(19) United States
(12) Patent Application Publication
(10) Pub. No.: US 2025/0270757 A1
(43) Pub. Date: Aug. 28, 2025

(54) SURFACTANT-LOADED MOF-BASED ANTIVIRAL FABRIC FOR USE IN FACEMASKS AND RESPIRATORS

(71) Applicant: DREXEL UNIVERSITY, Philadelphia, PA (US)

(72) Inventors: Gregory Ryan Schwenk, Philadelphia, PA (US); Donald Carl Hall, Philadelphia, PA (US); Hai-feng Ji, Cherry Hill, NJ (US); Garth David Ehrlich, Philadelphia, PA (US); Sonia Navas-Martin, Philadelphia, PA (US); Adam Glass, Philadelphia, PA (US)

(73) Assignee: Drexel University, Philadelphia, PA (US)

(21) Appl. No.: 18/859,908

(22) PCT Filed: May 1, 2023
(86) PCT No.: PCT/US2023/066420

§ 371 Date: Oct. 24, 2024

Related U.S. Application Data
(60) Provisional application No. 63/336,547, filed on Apr. 29, 2022.

(51) Int. Cl. D06M 16/00; D06M 13/463; D06M 13/50; D06M 15/03; D06M 101/20

(52) U.S. Cl. CPC D06M 16/00; D06M 13/463; D06M 13/50; D06M 15/03; D06M 2101/20

(57) ABSTRACT

A method for developing an antimicrobial includes coating a cyclodextrin-based metal-organic framework (CD-MOF-1) solution on a polypropylene fabric. The method further includes forming a MOF-coated fabric based on the CD-MOF-1 coating. The method further may load a benzalkonium chloride (BAC)-based surfactant on the MOF-coated fabric to develop the antimicrobial fabric.

### RELATED APPLICATION(S)

This application claims the benefit of U.S. Provisional Patent Application Ser. No. 63/336,547, filed on Apr. 29, 2022, which is assigned to the assignee hereof and hereby, expressly incorporated by reference as if fully set forth herein.

### FIELD OF THE INVENTION

The embodiments presented herein describe a surfactant-impregnated MOF-coated fabric. In particular, the embodiments describe a benzalkonium chloride (BAC)-based surfactant impregnated metal organic frameworks (MOF)-coated propylene fabric for antimicrobial applications.

### BACKGROUND OF THE INVENTION

Since the onset of the SARS-COV-2 pandemic, the world has witnessed over 617 million confirmed cases and more than 6.54 million confirmed deaths, but the actual totals are likely much higher. The virus has mutated at a significantly faster rate than initially projected, and positive cases continue to surge with the emergence of ever more transmissible variants. Further, more than 77% of all current United States cases are a result of the B.5 (omicron) variant. The continued emergence of highly transmissible variants makes clear the need for more effective methods of mitigating disease spread.

The COVID-19 pandemic has reinforced the current need for the development of better personal protective equipment (PPE) for both health care and health-related services such as laboratory sciences. Respirators are one of the most quintessential safeguards from infections for health care providers. Recently, the PPE industry has experienced a need for cheaper, producible, and more effective respirators. With the declaration of the SARS-COV-2 virus pandemic by the world health organization, the need has never been more evident. The COVID-19 respiratory illness as of date has infected over 617 million people and is responsible for almost 6.54 million deaths globally. What makes a virus such as the SARS-COV-2 so transmissible and virulent is its ability to spread by both contact transmission and aerosolized viral particles. Several studies have confirmed that the virus has a half-life of around 1 hour as aerosolized particles. The transmission of these respiratory viruses could be greatly attenuated by the employment of microbicides in PPE, such as respirators.

A more efficient and effective respirator could slow and even eliminate the spread of the SARS-COV-2 (or other) virus in many cases. The current standard of care is the N95 respirator, which is effectively a size exclusion-based system that traps particles within layers of fibers. Once these infectious particles are trapped within these layers, they are still biohazardous until either a decontamination process or the respirator is destroyed. The main drawback to the N95 respirators is that they are only able to capture 95% of particulate matter or less (i.e. bacteria, viruses, fungi).

The effectiveness of an N95 respirator relies on High-Efficiency Particular Air (HEPA) technology. A HEPA filter's efficiency relies on the use of pores to sequester particles based on their size. The average size of a captured particles is ˜300 nm in HEPA filters. This leaves many sub-100 nm particles free to pass through the filter. Viruses range anywhere in size from about 20 nm (e.g., parvovirus) to 200 nm (e.g., herpesvirus). While several others are larger, the most common viral pathogens fall in the range of 100 nm, i.e. influenza virus and, more relevant to this work, the SARS-CoV-2. Therefore, particulate decomposition, coupled with size exclusion, may enhance the efficiency of these filters.

Further, MOFs represent an interesting category of coordination polymers capable of being employed in a wide variety of applications. Fundamentally, MOFs are composed of metal nodes, either simply ions or metal oxide clusters referenced as secondary building units (SBUs), connected by organic ligands. These organic ligands must be polytopic, meaning they must be able to coordinate to two or more separate inorganic SBUs, thereby, extending the structure. Consequently, an entire three-dimensional framework can be generated by a repeating unit cell with distances that vary based on the size and chemical environment of the SBUs and organic linkers. Such a separation allows for an enormous free volume (up to 90%) via internal pores. These pores may be used to sequester and stabilize particular drug compounds via guest-host interactions. Since there are virtually limitless combinations of organic linkers and SBUs, these materials possess highly tailorable morphologies and pore sizes at the molecular or atomic level. Consequently, MOFs have recently received much interest as an improvement over other conventional inorganic porous materials (i.e. zeolites), finding applications in catalysis, energy storage, molecular sensing, drug delivery, air purification, and electronic/optoelectronic devices.

Therefore, there is a need to develop an MOF-based antimicrobial solution to overcome the challenges with conventional PPE equipment.

### SUMMARY OF THE INVENTION

Embodiments described herein disclose a method for developing an antimicrobial fabric that addresses at least some of the above challenges and issues. More specifically, the embodiments presented herein describe a cationic surfactant-loaded metal organic framework and its novel application as a nontoxic, antimicrobial material epitaxially grown on polypropylene fabric.

In an embodiment, the method for developing an antimicrobial fabric discloses coating a cyclodextrin-based metal organic framework (CD-MOF-1) solution on a polypropylene fabric. The method further includes forming an MOF-coated fabric based on the CD-MOF-1 coating. The method further discloses loading a benzalkonium chloride (BAC)-based surfactant on the MOF-coated fabric to develop the antimicrobial fabric.

Further, the embodiments presented herein additionally describe a method to synthesize an MOF from the nontoxic constituents of K+ and y-cyclodextrin and illustrate the MOF to be capable of loading BAC internally. In an embodiment, a method for synthesizing the CD-MOF-1 solution, is disclosed. The method includes dissolving 326 mg of γ-CD in a 10 milliliter (mL) solution of distilled water including 112 mg of KOH in a reaction flask to generate an aqueous reaction solution and then, sonicating the aqueous reaction solution for a time duration ranging between 5 to 10 minutes. The method further includes filtering the aqueous reaction solution through a 0.2 μm polyvinylidene filter paper via a syringe into a 20 mL test tube to form a filtered solution. The method further includes adding 1 mL EtOH to the filtered solution in the test tube as an emulsifier. The method further includes placing the test tube in a glass bottle that includes 10 mL MeOH, storing the glass bottle in a 50° C. oven for a time duration of 12 hours, removing the filtered solution from the glass bottle, and then, adding 1 mL MeOH to the removed solution to form an intermediate solution. The method further includes incubating the intermediate solution for a time duration of 2 hours at room temperature, collecting a solid precipitate from the intermediate solution through a 0.2 μm polyvinylidene filter paper, and then, washing the solid precipitate with EtOH and DCM. The method further includes placing the washed solid precipitate in a 50° C. vacuum oven for a predetermined time duration to form the CD-MOF-1 solution.

Additionally, the growth of this MOF on polypropylene fabric (common in masks and respirators) and its resulting properties are also described herein.

### BRIEF DESCRIPTION OF THE DRAWINGS

Further advantages of the invention will become apparent by reference to the detailed description of preferred embodiments when considered in conjunction with the drawings:

FIG. 1 illustrates a synthetic procedure of preparing a BAC-loaded MOF-coated Polypropylene Fabric, according to an embodiment.

FIG. 2A illustrates an Ultraviolet-visible spectroscopy (UV/Vis) profile of the BAC@MOF solution against BAC standards of 1, 10, and 50 ug·mL⁻¹, according to an embodiment.

FIG. 2B illustrates an adsorption isotherm for the unloaded MOF and BAC@MOF indicating a decrease in surface area respectively due to the occupation of the MOF pores by BAC, according to an embodiment.

FIGS. 3A-3B illustrate the Raman Spectroscopy-based and Powder X-Ray Diffraction (P-XRD) Profiles, respectively, of the loaded and unloaded γ-CD-MOF-1 powder indicating that the presence of BAC does not inhibit the MOF structure, according to an embodiment.

FIG. 4A illustrates zone of inhibition killing assay with Pseudomonas aeruginosa (PA01), Staphylococcus aureus (ATCC 25923), and Escherichia coli (Strain C), according to an embodiment.

FIG. 4B. illustrates the T4 Bacteriophage plaque assay, according to an embodiment.

FIG. 4C illustrates Murine coronavirus (Mouse hepatitis virus strain A59) plaque assay, according to an embodiment.

FIGS. 5A-5D illustrate a synthesis setup of BAC@MOF Polypropylene Fabric, according to an embodiment.

FIGS. 6A-6B illustrate XRD patterns indicating the observed changes in crystallinity after 1 year and over the course of 7 days, respectively, during exposure to ambient conditions with minimal changes to the low angle peaks, according to an embodiment.

FIGS. 7A-7F illustrate scanning electron microscopy images of pristine polypropylene fabric and MOF-coated fabric, according to an embodiment.

FIG. 8 illustrates an H NMR profile of BAC@MOF with relevant integration assignments, according to an embodiment.

FIG. 9 illustrates an optimized docking orientation for BAC-18 and vitamin A palmitate, according to an embodiment.

FIG. 10 illustrates a simulated P-XRD of CD-MOF-1, according to an embodiment.

FIG. 11 illustrates IR spectra of the BAC, BAC@MOF, and the unloaded MOF, according to an embodiment.

FIG. 12 illustrates a zone of inhibition assay for top (interfacial synthesis) and bottom (submerged synthesis) growth of MOF on polypropylene fabric, according to an embodiment.

FIG. 13 illustrates soft agar zone of inhibition assay with from left to right: Pseudomonas aeruginosa (PA01), Staphylococcus aureus (ATCC 25923), and Escherichia coli (C Strain), according to an embodiment.

### DETAILED DESCRIPTION

The following detailed description is presented to enable a person of ordinary skill in the art to make and use the invention. For purposes of explanation, specific details are set forth to provide a thorough understanding of the present invention. It will be apparent to one skilled in the art, however, that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown but is to be accorded the widest possible scope consistent with the principles and features disclosed herein.

The embodiments presented herein disclose an antimicrobial fabric capable of destroying a myriad of microbes including, but not limited to, betacoronaviruses. The antimicrobial fabric is highly porous and includes a nontoxic metal organic framework (MOF), γ-CD-MOF-1, which makes the fabric capable of serving as a host for varied-length BAC (active ingredient in Lysol®). During an experimental study, molecular docking simulations predicted a binding affinity of up to −4.12 kcal mol⁻¹, which is comparable to other reported guest molecules for this MOF. Similar Raman spectra and P-XRD patterns between the unloaded and loaded MOFs, accompanied by a decrease in the BET surface area from 616.20 m²g⁻¹ and 155.55 m²g⁻¹ respectively, corroborate the suggested potential for pore occupation with BAC. The MOF was grown on a polypropylene fabric, exposed to a BAC-loading bath, washed to remove excess BAC from the external surface, and evaluated for its microbicidal activity against various bacterial and viral classes.

During an experimental study to implement the embodiments described herein, significant antimicrobial character was observed against Pseudomonas aeruginosa, Staphylococcus aureus, Escherichia coli, bacteriophage, and betacoronavirus. This experimental study illustrated that a common mask material such as polypropylene can be coated with BAC-loaded γ-CD-MOF-1 while maintaining the guest molecule's antimicrobial effects.

Although a large portion of conventional MOF-based research focuses on energy storage, some large-pore MOFs have been synthesized as adequate drug delivery systems. In these instances, the large surface area, based on their porous nature, allow for regions in which the drugs may be stored by surface adsorption. Fe-MIL-100 has demonstrated a loading capacity of up to 46% of flurbiprofen, a potent anti-inflammatory drug, to serve as an efficient drug delivery system.

Presenting lower toxicity with a highly flexible structure, cyclodextrin-based MOFs (CD-MOFs) have also proven an effective mode of drug delivery. These CD-MOFs have been shown capable of effectively encapsulating several drugs with loading capacities as high as 151%. Additionally, these CD-MOFs can encapsulate drugs as large as Vitamin A Palmitate (VAP), measuring as long as 26 Å (2.6 nm) (optimized and measured using force field OPLS3e).

Bearing similarity to VAP in size and chemical structure, BACs are a class of cationic surfactants commercially found in the disinfectant, Lysol®. If successfully impregnated into a CD-MOF analogously with the VAP literature, subsequent liberation of BAC from the pores of these MOFs may successfully exhibit antimicrobial properties. When exposed to regions with relatively high humidity (i.e., exhalation through a mask), the degree of crystallinity in these MOFs decreases, thereby, freeing the sequestered BAC.

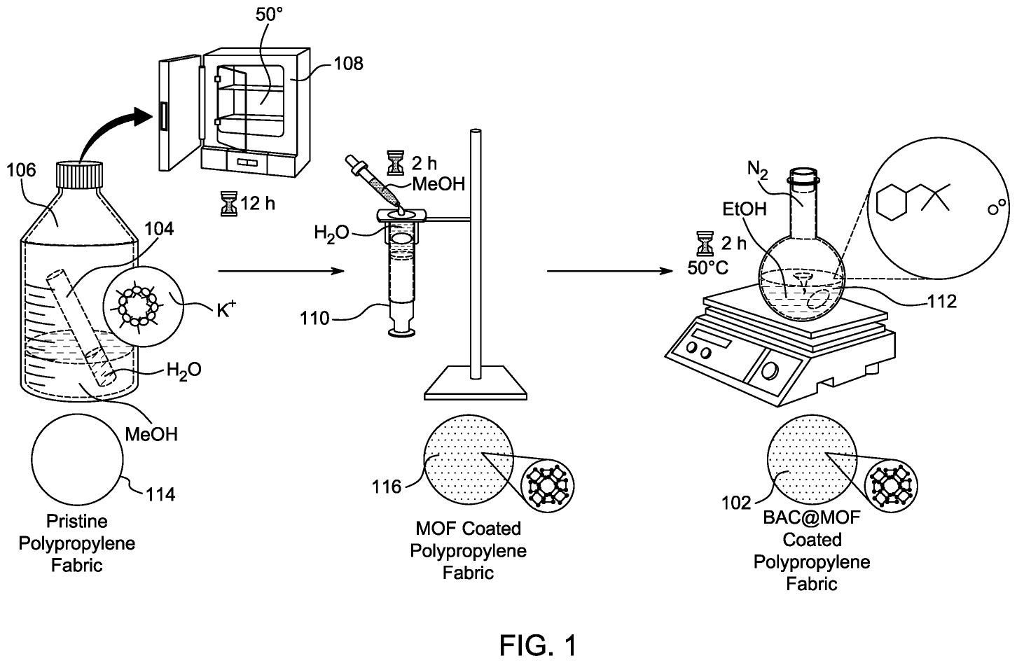

FIG. 1 illustrates a synthetic procedure of preparing a BAC-loaded MOF-coated Polypropylene Fabric 102. In an embodiment, BAC-loaded MOF-coated Polypropylene Fabric 102 may be referred to as BAC@MOF or BAC@MOF coated Polypropylene Fabric 102.

In an embodiment, this method includes γ-CD-MOF-1 synthesis as a part of preparing BAC@MOF coated Polypropylene Fabric 102. To prepare the γ-CD-MOF-1 solution (or CD-MOF-1 solution), an aqueous reaction solution including an 8:1 molar ratio of KOH:γ-CD is generated. Briefly, approximately 326 mg (ca. 0.25 mmol) of γ-CD is dissolved in a 10 mL solution of distilled water containing ˜112 mg (ca. 2 mmol) of KOH, in a reaction flask. The reaction flask is then sealed with a rubber stopper and sonicated for 5-10 minutes. The solution in the reaction flask is then filtered through 0.2 μm polyvinylidene filter paper via syringe into a ˜20 mL test tube 104 to form a filtered solution. Approximately 1 mL EtOH is added to the test tube solution as an emulsifier. The solution-containing test tube 104 is placed in a large glass bottle 106 including approximately 10 mL MeOH.

The glass bottle 106 is then sealed and stored in a 50° C. oven 108 for approximately 12 hours. Crystal formation on the inner wall of the glass test tube 104 is observed over this time duration. After 12 hours, the solution is removed from the glass bottle 106 and ˜1 mL MeOH is added to the removed solution to form an intermediate solution 110. This intermediate solution 110 is allowed to incubate for a period of ˜2 hours at room temperature in another flask 112. After this time duration, solid precipitate that is formed in the flask 112 is collected by vacuum filtration through 0.2 μm polyvinylidene filter paper. The solid precipitate is then washed several times with EtOH and DCM (including but not limited to dichloromethane or methylene chloride) before being placed in a 50° C. vacuum oven for a period of approximately 24 hours to form the γ-CD-MOF-1.

In an embodiment, a reaction solution identical to that of the γ-CD-MOF-1 synthesis described above, is generated. Two separate procedures are evaluated as methods for coating a 0.9 mm disc of polypropylene fabric 114, herein referred to as the interfacial synthesis and the submerged synthesis.

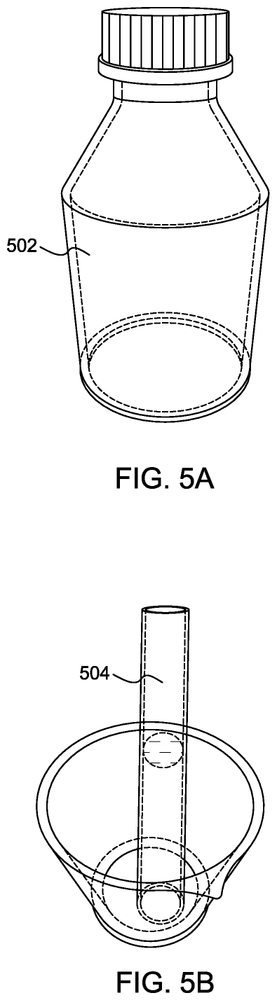

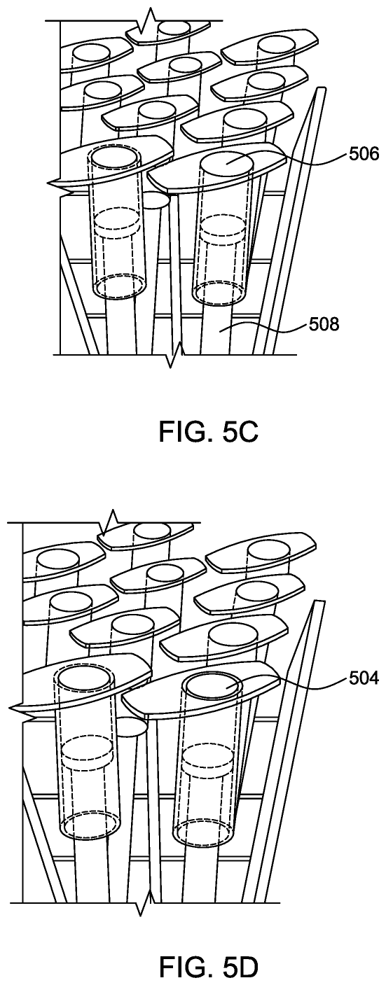

Interfacial Synthesis: The elevated temperature incubation is performed as outlined in the γ-CD-MOF-1 synthesis. During the room temperature incubation, the polypropylene fabric 114 is placed on the meniscus of the solution 110 being incubated, and the methanol additions are made directly to the top of the polypropylene fabric 114. The methanol disperses through the polypropylene fabric 114 and into the incubating solution 112 where precipitation occurs (as illustrated in FIG. 5C).

Submerged Synthesis: The polypropylene fabric 114 is submerged in the reaction solution during the entire elevated temperature incubation as well as the room temperature incubation (as illustrated in FIG. 5D).

Once the above two methods are completed, the MOF-coated fabrics resulting from both the interfacial and submerged synthetic methods are then dipped sequentially in 3 EtOH baths and 1 DCM bath. The coated fabrics are then allowed to dry in a vacuum oven at 50° C. for 24 hours (as illustrated in FIG. 1).

MOF@BAC Fabric loading: Approximately 40 mg of BAC is dissolved in 1 mL of EtOH. One or two 0.9 mm discs of MOF-coated fabric are added to the suspension, and the suspension is heated under gentle stirring at 50° C. for approximately 2 hours. The fabric is removed from the solution and submerged briefly in 3 sequential baths of EtOH followed by 1 bath of DCM to ensure any residual BAC is removed. The fabric is then dried in a vacuum oven at 50° C. for 24 h (FIG. 1).

Brunauer-Emmett-Teller (BET) Surface Area Analysis: Approximately 100 mg of sample, both the loaded and unloaded γ-CD-MOF-1, was measured and transferred to the sample tube of a Coulter SA-3100. The sample was then outgassed for a period of 15 minutes at 40° C. and its new outgassed mass was recorded. The sample was then cooled to −196° C. and Nitrogen adsorption was measured.

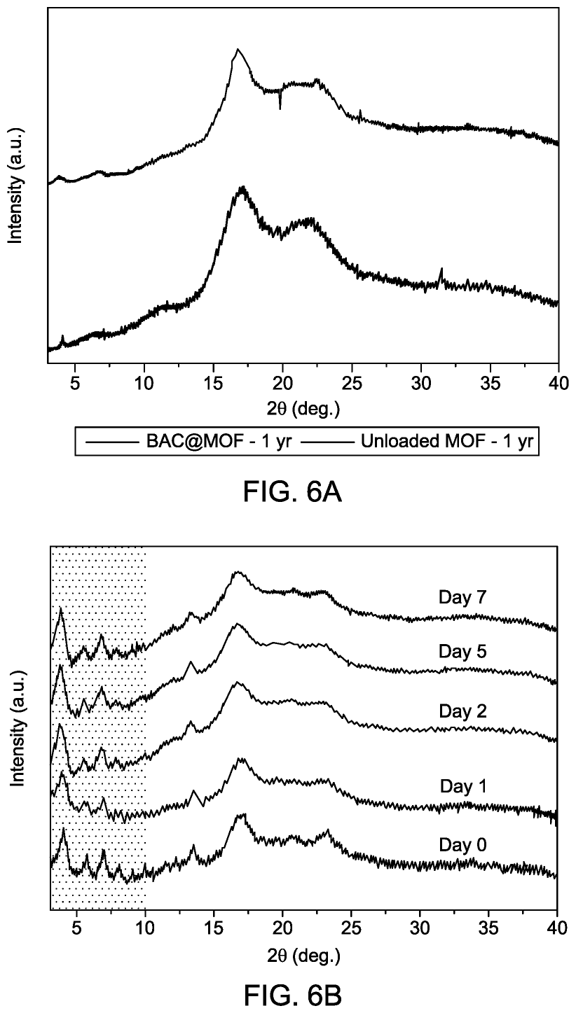

Powder XRD: Approximately 100 mg of sample, both the loaded and unloaded γ-CD-MOF-1, was measured and transferred to an Agate mortar, where each sample was subsequently finely ground for a period of 10-15 minutes. Diffraction patterns were acquired in the range of 3-45° with a step increase of 0.02° and a dwell time of 1 s using a Rigaku MiniFlex equipped with a Cu αK radiation source. Stability of the loaded MOFs was assessed by observing crystallinity as indicated by the XRD patterns when exposed to ambient conditions. BAC@MOF samples were subjected to varied humidity (27-44% RH) and temperature (22.5° C.-23.9° C.) over a period of 7 days. In one example, XRD patterns obtained on days 0, 1, 2, 5, and 7 are illustrated in FIG. 6B).

Raman Spectroscopy: A small amount of sample, both the loaded and unloaded γ-CD-MOF-1, were loaded onto a glass microscope slide. A Renishaw RM-2000 Vis Raman Spectrometer was used to probe the observed Raman shifts in each sample with a 633 nm beam source. While exposed to a 10% laser strength, 10 accumulations were acquired at a 10 second exposure time each.

UV/Vis: Approximately 2.7 mg of BAC@MOF is dissolved in 1 mL distilled water and diluted with isopropyl alcohol to a total volume of 3 mL. Stock solutions of 1, 10, 50, and 100 μg·mL⁻¹ are generated in a 2:1 solvent system of isopropyl:water (this system also served as a blank). An Agilent HP 8453 UV-Vis Spectrophotometer is employed to measure the UV profile of the standard solutions and the dissolved BAC@MOF solution in the range of 190-1100 nm. The peak at 198 nm is observed to possess a molar absorptivity in the range of 104, characteristic of the benzene moiety in BAC regardless of chain length.

Nuclear Magnetic Resonance (NMR) Spectroscopy: A 10 mg sample of BAC@MOF was dissolved in D₂O for NMR analysis. H Spectrum is acquired on a Varian Inova 500 (at 500 MHz) using Agilent VnmrJ 4.2 software with 64 scans. NMR data was processed using MestReNova version 14.1.1-24571 compound peaks were integrated after a Bernstein Polynomial Fit order baseline correction. Benzalkonium chloride aromatic H's (5 protons) are determined at 7.4 ppm and integrated to 1.00. Two γ-CD peaks are utilized occurring ˜5.0 ppm (8 protons) and ˜3.25-4.0 ppm (48 protons). Integration normalization is determined by dividing the integrated areas by the number of protons. The percent BAC is calculated as a ratio of the normalized integration of the BAC/γ-CD. The final reported percentage is determined by averaging the two ratios.

Bacterial Zone of Inhibition: Soft agar plates are prepared by combining 1:1 Lysogeny broth (LB) agar (1.5%) and LB broth while hot. The subsequent (0.75%) agar is cooled to 37° C. and 3% by volume of overnight cultures of either E. coli, S. aureus, or P. aeruginosa is added. 5 mL of the inoculated soft agar is poured on LB (1.5% agar) plates. Soft agar is then allowed to solidify. BAC@MOF coated polypropylene fabric and controls are placed atop the solidified soft agar and placed at 37° C. overnight. Zones of inhibition were measured with a standard caliper. In the above embodiment, bacterial species include Pseudomonas aeruginosa (PA01), Staphylococcus aureus (ATCC 25923), and Escherichia coli (C Strain27).

T4 Phage Viability Assay: The BAC@MOF coated polypropylene fabric and controls are placed in separate wells on 48-well culture plate. 400 μL of T4 phage stock is added (8×10⁷ pfu·mL⁻¹). Phage and MOF materials were incubated for 30 min at shaking at 225 rpm at 30° C. Liquid is collected (10 μL) and diluted 1:10,000. E. coli (MG1655) overnight culture (150 μL) was mixed with 50 μL of diluted phage solution. 150 μL of the phage E. coli mixture is added to 3 mL of soft agar and plated on LB agar plates. The plates were incubated at 37° C. for 48 hours. Plaques were then counted and recorded; data was normalized to control.

In silico Docking of Molecules of Interest into CD-MOF: γ-CD-MOF-1 structure is downloaded from the Cambridge Crystallographic Data Centre (CCDC) database (Database Identifier: LAJLAL; Deposition Number: 773709). Using Mercury (2020.3.0 [Build 298224]), the structure is packed to fill out a until cell (a: 0.0-1.0, b: 0.0-1.0, c: 0.0-1.0). This packed unit cell *.cif file is then converted to a *.pdb file format to be loaded into Maestro (Glide Version 8.9.144, MMshare Version 5.2.144, Release 2020-4, Platform Windows-x64, Schrodinger Maestro, New York, NY, USA). Utilizing all original structure coordinates a docking grid is created with the grid center being 16.0, 16.0, 16.0 (innerbox: 10, 10, 10; outerbox: 41, 41, 41). Ligands (vitamin A palmitate, BAC-18, BAC-8) are geometry minimized using a semiempirical force field OPLS3e using Schrodinger's structure minimization tool. Ligands are docked into the structure using Glide Docking XP precision. Poses and docking energies are assessed using the Schrödinger Maestro interface.

Murine Coronavirus Plaque Assay: MOF coated polypropylene fabric discs and controls (virus alone, pristine polypropylene, polypropylene with empty MOF, and polypropylene exposed to the BAC loading protocol) are incubated with 1×10⁷ total plaque forming units (PFU) of mouse hepatitis virus strain MHV-A59 (initial stock titer of 6.0×10⁷ PFU·mL⁻¹) in a 48-well plate for 30 minutes with rocking at room temperature. Tenfold serial dilutions of virus samples are then prepared in Dulbecco's minimal essential medium (DMEM) with 4.5 g·L⁻¹glucose, 2 mM L-glutamine, 1 mM sodium pyruvate, 1 μg·mL⁻¹ ciprofloxacin and 2% heat-inactivated fetal bovine serum (FBS). Virus titers are determined via plaque assay in a murine fibroblast cell line (L2 cells).

Mouse fibroblast L2 cells are seeded in 6-well plates (1.0×10⁶ cells·well⁻¹) and incubated overnight at 37° C. with 5% CO₂. Cells were infected with virus dilutions in duplicate in a volume of 250 μL per well. During one hour of virus adsorption, plates were rocked every 15 minutes followed by an overlay of 2 mL per well of 10% FBS-DMEM media mixed 1:1 with 1.6% agarose. A neutral red (5%) overlay was added 48 hour post-infection, and plates were left to incubate for 6 hours before virus plaques were counted.

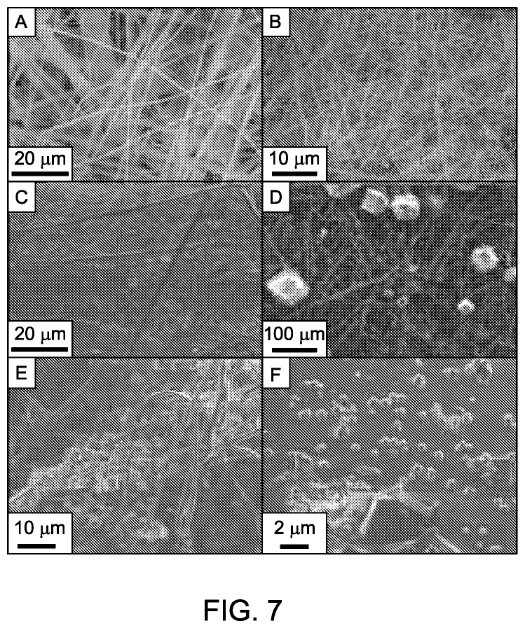

After establishing the successful synthesis of γ-CD-MOF-1, a similar procedure is utilized in the presence of polypropylene fabric to facilitate the growth of MOF crystals on the fabric. During the elevated temperature and room temperature incubation periods, the fabric remains fully submerged. Based on visual observation of crystal formation, the initial crystallization begins occurring at the surface of the fabric during the elevated temperature incubation, thereby serving as nucleation sites while the rest of the MOF precipitated during the room temperature incubation. SEM images highlight the existence of both micron and nano sized crystals of the MOF present on the fabric (as illustrated in FIG. 7A-F). The nano crystals can be found both on the surface of the micron-sized crystals as well as in between fibers of the polypropylene fabric. BAC loading conditions of MOF coated fabric remained largely the same.

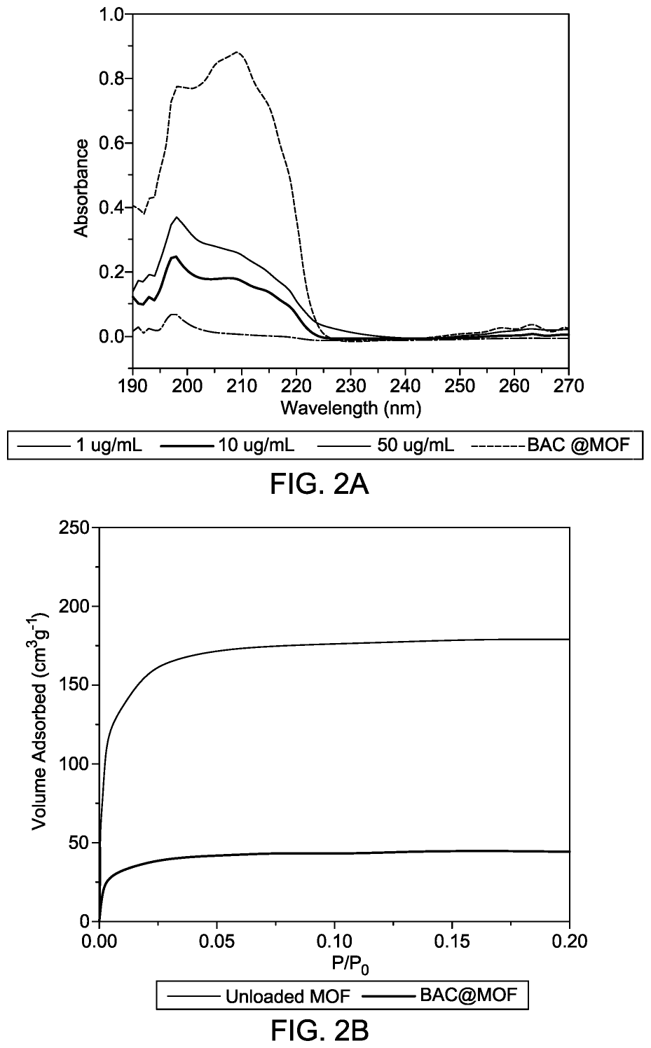

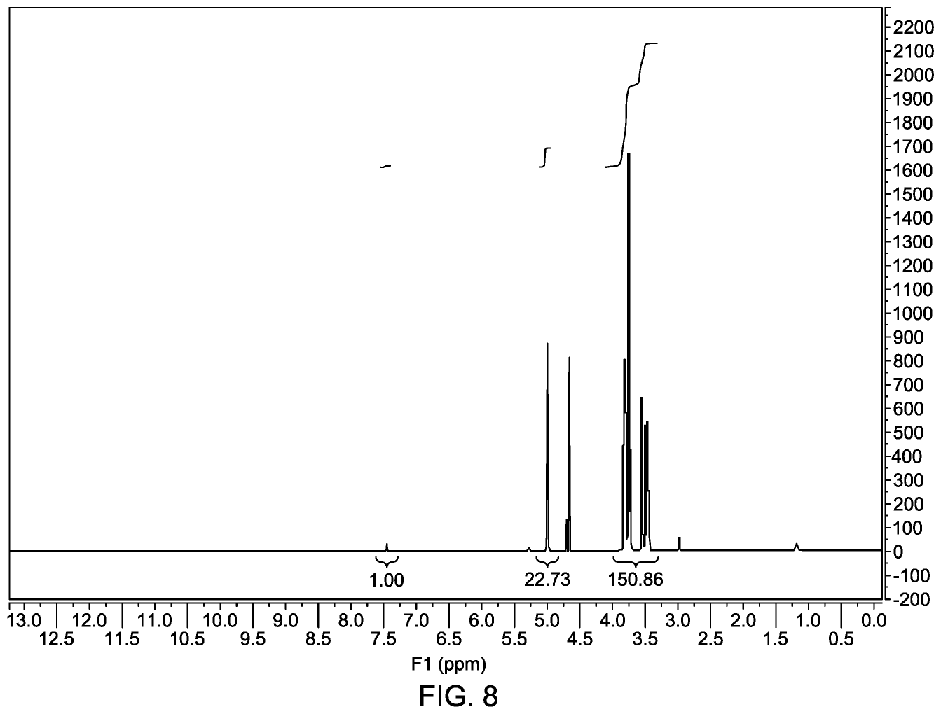

FIG. 2A illustrates an Ultraviolet-visible spectroscopy (UV/Vis) profile of the BAC@MOF solution against BAC standards of 1, 10, and 50 ug·mL⁻¹. As illustrated in FIG. 2A, owing to the πà π* transitions of the benzene moiety, UV/Vis spectroscopy is employed as a method for determining the mass percent loading. The loaded MOF coated fabric samples are submerged in a water/i-pr solvent system to dissolve the BAC@MOF material and are evaluated for a mass loading of 2.5-5%. Furthermore, samples of BAC@MOF are dissolved in D₂O and their H NMR profiles were acquired (as illustrated in FIG. 8). The integration values of γ-CD signals are evaluated alongside the BAC signals, serving as an internal standard to assess the loading percentage of BAC. Through this technique, an average loading of 6.70% BAC is observed. While this is in a similar range as the UV/Vis results, the NMR assessment is likely more accurate. This is because the broadened signal for BAC in the UV/Vis profile introduces ambiguity regarding the λₘₐₓ of the spectrum, thereby influencing the calibration curve used to determine the amount of BAC present. To assess whether the BAC is entering the pores, molecular docking scores are acquired and BET surface area is calculated. The stock BAC possesses a quaternary ammonium salt with a varied length alkyl chain. Thus, computational modeling is performed for the shortest chain (n=8) and the longest chain (n=18).

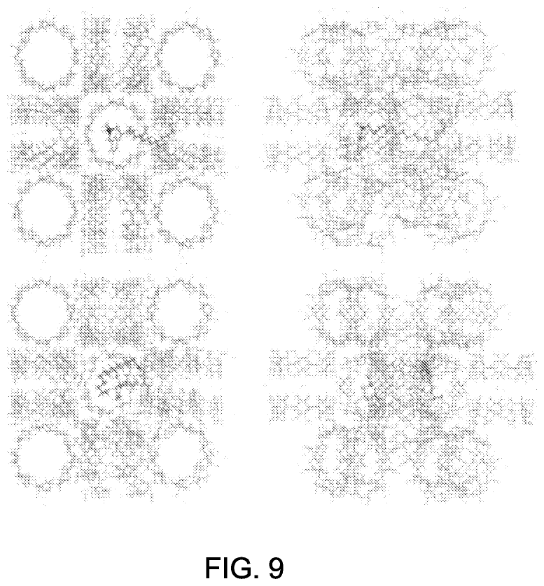

The docking scores observed are comparable to that of Vitamin A Palmitate (as illustrated in Table 1 below) which has been established in literature as a guest molecule for γ-CD-MOF-1, suggesting pore occupation may also be possible for BAC (as illustrated in FIG. 9). BET surface area calculations are performed on both the free unloaded and BAC-loaded materials resulting in 616.20 m²g⁻¹and 155.55 m²g⁻¹respectively, further corroborating the claim of pore occupation.

FIG. 2B illustrates an Adsorption isotherm for the unloaded MOF and BAC@MOF indicating a decrease in surface area respectively due to the occupation of the MOF pores by BAC. It is worth noting that, due to the constraints of the BET analysis logistics, surface area tests are run with the free MOF rather than the MOF grown on fabric (as illustrated in FIG. 2B). To maintain consistency with the fabric samples, the free MOF is not activated prior to the surface area analyses and is instead loaded as synthesized. As a result, calculated surface areas are below those reported in literature, however, further characterization techniques were employed to ensure the identity of γ-CD-MOF-1. Since the MOF itself is readily decomposed in water, the inclusion of a cationic surfactant as a guest molecule may result in a decrease in crystallinity and therefore structural characterization must be observed before and after loading.

TABLE 1
Molecular docking scores outlining ligand
binding affinity within γ-CD-MOF-1 pore.

| | Docking Score |
|---|---|
| Ligand | (kcal · mol⁻¹) |
| Vitamin A Palmitate | −5.94 |
| BAC-18 | −4.12 |
| BAC-8 | −2.24 |

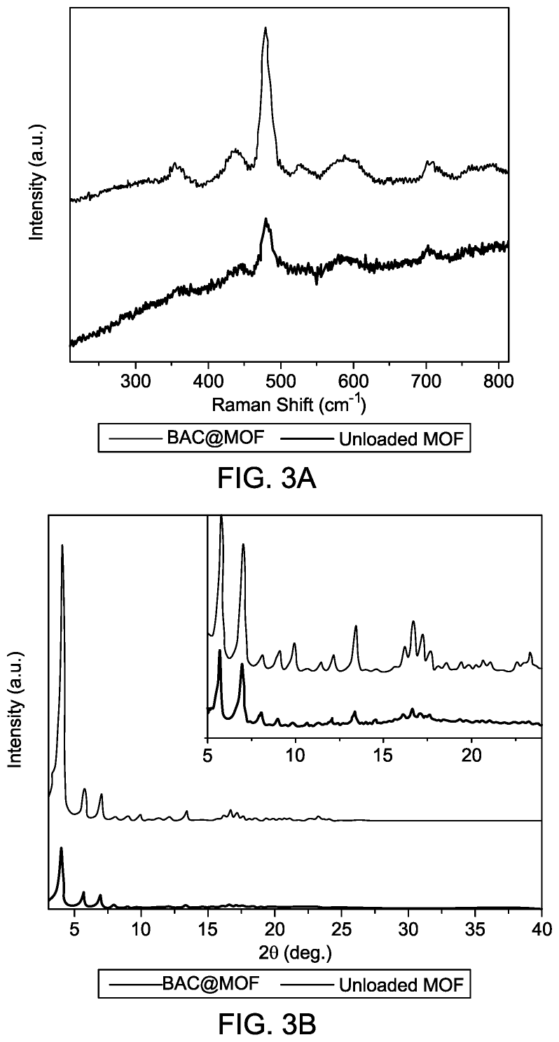

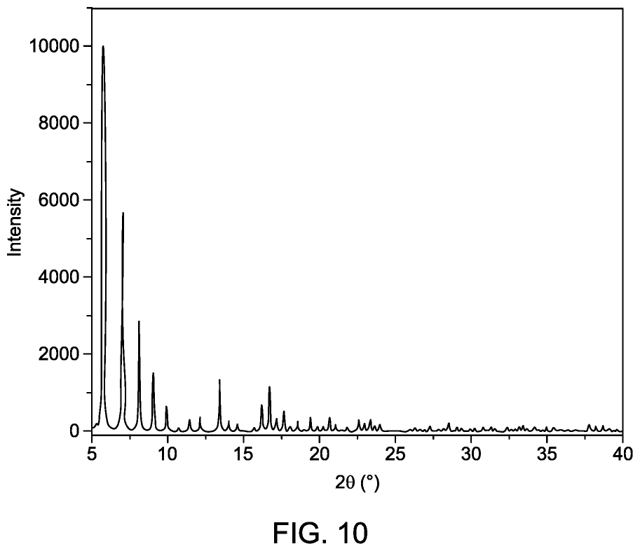

FIG. 3A-3B illustrate the Raman and P-XRD Profiles, respectively, of the loaded and unloaded γ-CD-MOF-1 powder indicating that the presence of BAC does not inhibit the MOF structure. Structural characterization is assessed via powder XRD and Raman profiles. Diffraction patterns are acquired for both the unloaded and BAC-loaded MOFs and compared to the simulated XRD. A diffraction pattern for the pristine MOF is simulated in Mercury from an existing CIF file and used as a basis for comparison (as illustrated in FIG. 10).

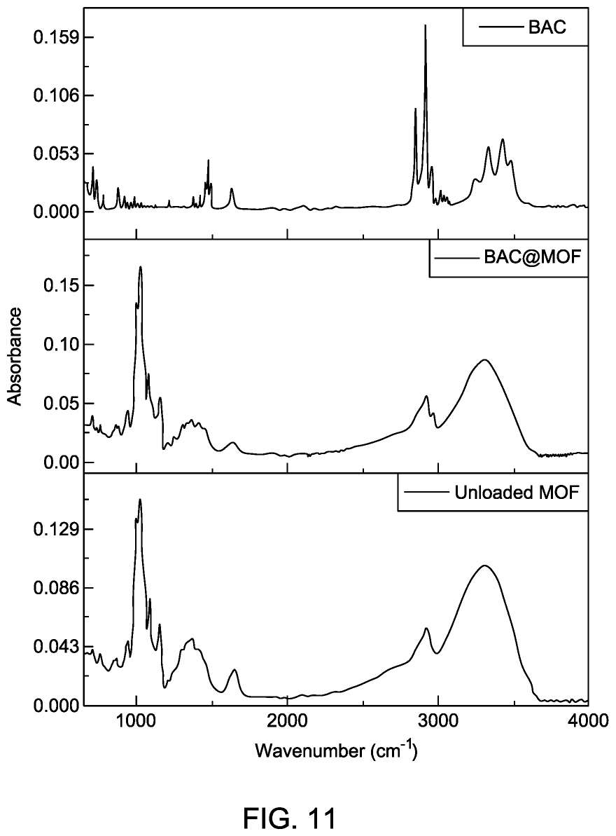

As evidenced in the similarity between their P-XRD patterns, particularly the signals at 5.4°, 7.3°, and 16.7°, characteristic peaks of the MOF remain unchanged before and after BAC loading, suggesting crystallinity is maintained. In fact, the loaded material exhibits sharper, more defined peaks in the XRD and Raman profiles compared to the unloaded analog. This is likely a result of unintentional solvent exchange and subsequent pore activation. The unloaded MOF is crystallized from a solution containing mostly water, while the loaded MOF is exposed to a bath containing only ethanol and BAC at elevated temperatures for two hours. During the loading process, it is likely that residual water trapped in pores may have solvent exchanged with ethanol. Owing to its higher volatility, the ethanol is likely driven off to a higher degree during the drying process, thereby enhancing both the XRD pattern and vibrational modes present. IR studies are employed for both cases in order to corroborate this claim, however, due to similar windows of activity, additional insight was not gained (as illustrated in FIG. 11) during experiments. Further investigation of this phenomenon may be required to confirm the hypothesis. In any case, experimental analyses corroborate the computationally-suggested possibility of pore occupation in γ-CD-MOF-1 with BAC. The MOF is then grown on polypropylene fabric, loaded with BAC, and evaluated for antimicrobial character.

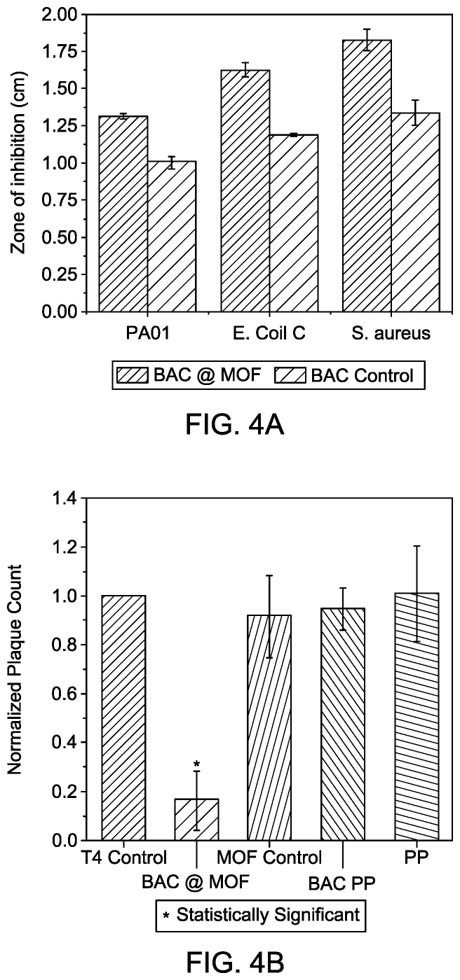

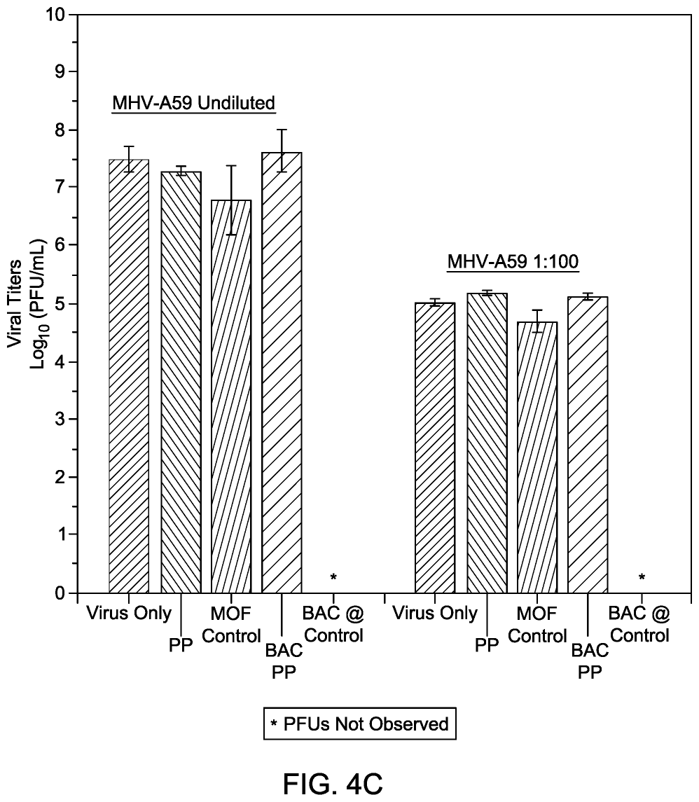

FIG. 4A illustrates zone of inhibition killing assay with Pseudomonas aeruginosa (PA01), Staphylococcus aureus (ATCC 25923), and Escherichia coli (Strain C). During an experimental study, the BAC@MOF coated fabric was assessed for its ability to act as an effective antimicrobial material for medical applications. A representative group of bacteria (Pseudomonas aeruginosa, Staphylococcus aureus, and Escherichia coli) and two viral classes (bacteriophage T4 and betacoronavirus) were used to show antimicrobial effectiveness of the BAC@MOF coated fabric, in an experimental study. These studies show that a common mask material (polypropylene) can be coated with γ-CD-MOF-1 and impregnated with a surfactant.

Bacteria subjected to the BAC@MOF coated fabric showed significant killing compared to that of a BAC coated fabric control (the control was exposed to identical conditions as BAC@MOF, i.e., loading bath and post-bath EtOH/DCM washes). It is known that coating polypropylene materials is an effective way to provide antimicrobial conditions. However, this method relies on the affinity of BAC with the polypropylene material. With the BAC@MOF coated fabric, more BAC is retained after the washing steps than in the case of the uncoated fabric, as is illustrated in FIGS. 4B and 4C.

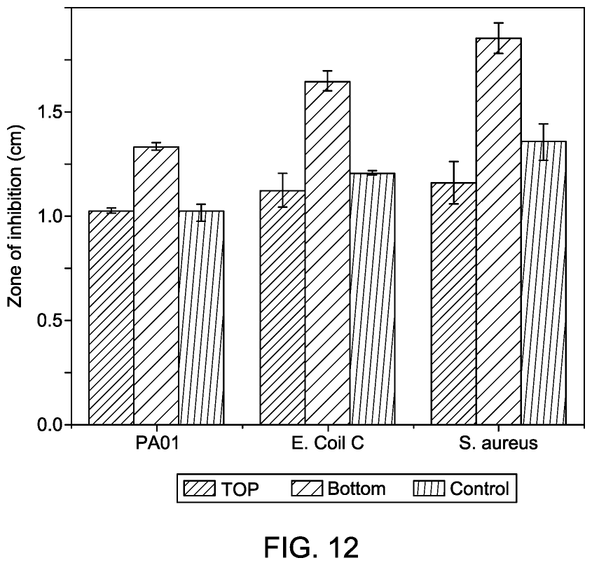

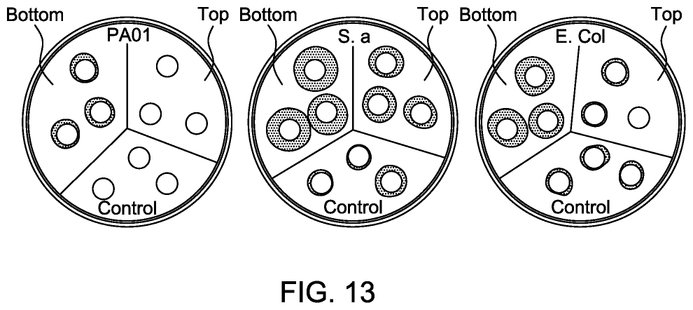

Furthermore, based on stability reports in atmospheres of high humidity, it is hypothesized that the release of BAC is also a function of MOF degradation in these environments and is therefore, humidity actuated. Utilizing a zone of inhibition killing assay with soft-agar plates, it was observed that there was a significant increase in killing ability with the BAC@MOF compared to that of just BAC treated fabric. Both P. aeruginosa and E. coli are Gram-negative bacteria that are less susceptible to killing induced by cationic surfactants and this is highlighted when compared to the zone of inhibition noted in the S. aureus system which is a Gram-positive bacterium. For all three bacterial species there was approximately a 30% increase in killing ability of the BAC@MOF compared to the BAC treated polypropylene (FIGS. 4A and 12). It was also noted that the submerged method was ideal for the synthesis of the material (FIG. 13).

During an experimental study, two viral systems were tested to show a broad range of antimicrobial abilities. Bacteriophages, specifically Escherichia coli virus T4, were utilized to determine the antimicrobial ability of the BAC@MOF coated polypropylene fabric. T4 bacteriophages consist of a complex protein architecture and are notably more difficult to inactivate than viruses that are enveloped via a lipid membrane. FIG. 4B shows a normalized to control BAC@MOF plaque assay. Analysis shows a reduction in plaque formation by roughly 85% while there is no statistical difference between the MOF, BAC treated PP, PP fabric, and untreated T4 phage control.

Further, FIG. 4C illustrates Murine coronavirus (Mouse hepatitis virus strain A59) plaque assay. Notably, for each plot window, PP=polypropylene fabric (pristine), MOF=unloaded γ-CD-MOF-1 coated polypropylene, BAC PP=polypropylene fabric exposed to BAC loading and washing protocol, BAC@MOF=BAC-loaded γ-CD-MOF-1 on polypropylene fabric. Mouse hepatitis virus strain MHV-A59, a betacoronavirus, was chosen as the second viral model system as the prototype betacoronavirus and a biosafety level 2 (BSL2) SARS-COV-2 model. After treatment with the coated fabric and compared to the controls it was noted that there was no plaque formation indicating a complete inactivation of the murine coronavirus virions (as illustrated in FIG. 4C). MOF, BAC treated PP, PP fabric and untreated MHV-A59 virus showed no significant difference in plaque formation. These virus models indicate the effectiveness of the BAC@MOF material to enhance the antimicrobial abilities of polypropylene fabric and ergo common masking and respirator materials.

FIGS. 5A-5D illustrate a synthesis setup of BAC@MOF Polypropylene fabric, as described in the context of FIG. 1. FIG. 5A illustrates a Methanol vapor diffusion growth chamber 502 with a test tube 504. FIG. 5B illustrates the test tube 504 after 20 hours at 50° C. FIG. 5C illustrates a Top Interfacial synthesis method (fabric 506 placed on top of liquid 508 and method dropped through the fabric 506). FIG. 5D illustrates a Bottom submerged synthesis method (fabric disc submerged and methanol dropped into liquid).

FIGS. 6A-6B illustrate XRD patterns indicating the observed changes in crystallinity after 1 year and over the course of 7 days, respectively, during exposure to ambient conditions with minimal changes to the low angle peaks.

FIGS. 7A-7B illustrate pristine polypropylene fabric fibers. FIG. 7C illustrates MOF crystals between fabric fibers. FIG. 7D illustrates large micron-sized MOF crystals atop fabric and small-micron/nano sized crystals attached to fibers. FIG. 7E illustrates small-micron and nano sized MOF crystals grown on and between fabric fibers. FIG. 7F illustrates small-micron and nano sized MOF crystals atop the surface of a large-micron crystal (all illustrated images are post-processed using ImageJ software).

FIG. 8 illustrates an H NMR profile of BAC@MOF with relevant integration assignments, as described in the context of FIG. 2A.

FIG. 9 illustrates an optimized docking orientation for BAC-18 (top two images) and vitamin A palmitate (bottom two images), as described in the context of FIG. 2A.

FIG. 10 illustrates a simulated P-XRD of Cyclodextrin Metal-Organic Framework. Simulated from CCDC database (Database Identifier: LAJLAL; Deposition Number: 773709) 1 using Mercury (2020.3.0 [Build 298224]), as described in the context of FIGS. 3A-3B.

FIG. 11 illustrates IR spectra of the BAC (top), BAC@MOF (middle), and the unloaded MOF (bottom), as described in the context of FIGS. 3A-3B.

FIG. 12 illustrates a zone of inhibition assay for top (interfacial synthesis) and bottom (submerged synthesis) growth of MOF on polypropylene fabric, as described in the context of FIGS. 4A-C.

FIG. 13 illustrates a soft agar zone of inhibition assay with from left to right: Pseudomonas aeruginosa (PA01), Staphylococcus aureus (ATCC 25923), and Escherichia coli (C Strain), as described in the context of FIGS. 4A-C.

While the first targeted application is a mask fabric, the embodiments herein describing BAC@MOF present a novel approach to implementing antimicrobial properties on various substrates such as wound dressings, medical coatings, and antimicrobial household materials. The delivery of the antimicrobial agent is unique for these materials in that it is only released once the framework degrades in the presence of humidity; a process that occurs over time. For practical purposes, stability was assessed over a period of 7 days and monitored by XRD (as illustrated in FIG. 6). A significant change was not observed in the low angle peaks of the XRD pattern which has been shown to be indicative of degradation from humidity. However, when the sample was sealed under ambient humidity and stored for a period of 1 year, long range crystallinity was remarkably diminished. Owing to this unique delivery method, epitaxial growth of γ-CD-MOF-1 could also open indications such as slow release of antibiotic compounds. Additionally, because of this MOF-degradation mechanism, it is important to acknowledge the degradation process results in a reproduction of the initial constituent materials γ-cyclodextrin and K⁺. Thus, if the fabric containing the decomposed framework is submerged in water, the incubation solution is effectively regenerated, and the surface-recrystallization process may potentially be performed again. Although the BAC-loading bath treatment would need to be replicated, these materials are potentially recyclable.

The embodiments presented herein describe the isolation of a cationic surfactant in a nontoxic MOF for antimicrobial applications. The growth of both micro and nanoscale crystals of γ-CD-MOF-1 on the surface of polypropylene fabric is facilitated by chemical vapor diffusion of methanol into a reagent solution containing the fabric. Docking scores as high as −4.12 kcal·mol⁻¹ indicate favorable interactions between the cationic surfactant, benzalkonium chloride, and the chemical environment of γ-CD-MOF-1 pores. Along with NMR analysis suggesting 6.70% BAC, UV/vis data reveals a loading capacity of 2.5-5% by mass, observations which are both corroborated with a decrease in the BET surface area from 616.20 to 155.55 m²g⁻¹. The powder XRD pattern in tandem with the Raman profile of the MOF before and after loading the surfactant indicates crystallinity of the material is not compromised when BAC occupies the pore. The resulting BAC@MOF fabric exhibits strong (˜30% increase) inhibition against the bacteria Pseudomonas aeruginosa, Staphylococcus aureus, and Escherichia coli—versus controls. Additionally, BAC@MOF exhibits strong antiviral activity when exposed to T4 bacteriophage and a murine betacoronavirus, resulting in ˜85% and 100% reduction in plaque counts versus control, respectively. BAC@MOF presents a humidity-actuated release of an antimicrobial agent hosted in a highly porous nontoxic material. These results present a high potential for advancement and further application in both medical and household materials.

One or more standard laboratory equipment and/or computer-readable storage media may be utilized in implementing embodiments consistent with the present disclosure. A person skilled in the art would understand that all laboratory equipment described in this disclosure may be connected to a local or a remote server unit for implantation of any processing tasks to implement the presented embodiments. Further, the computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

### EMBODIMENTS

Embodiment 1. A method for developing an antimicrobial fabric, the method comprising:
coating a cyclodextrin-based metal organic framework (CD-MOF-1) solution on a polypropylene fabric;
forming an MOF-coated fabric based on the CD-MOF-1 coating; and
loading a benzalkonium chloride (BAC)-based surfactant on the MOF-coated fabric to develop the antimicrobial fabric.

Embodiment 2. The method of embodiment 1, wherein the CD-MOF-1 solution is developed by:
dissolving 326 mg of γ-CD in a 10 mL solution of distilled water including 112 mg of KOH in a reaction flask to generate an aqueous reaction solution comprising an 8:1 molar ratio of KOH:γ-CD; sonicating the aqueous reaction solution for a duration ranging between 5 to 10 minutes;
filtering the aqueous reaction solution through a 0.2 μm polyvinylidene filter paper via a syringe into a 20 mL test tube to form a filtered solution;
adding 1 mL EtOH to the filtered solution in the test tube as an emulsifier;
placing the test tube in a glass bottle having 10mL MeOH;
storing the glass bottle in a 50° C. oven for a duration of 12 hours;
removing the filtered solution from the glass bottle;
adding 1mL MeOH to the removed solution to form an intermediate solution;
incubating the intermediate solution for a duration of 2 hours at room temperature;
collecting a solid precipitate from the intermediate solution through a 0.2 μm polyvinylidene filter paper;
washing the solid precipitate with EtOH and DCM; and
placing the washed solid precipitate in a 50° C. vacuum oven for a predetermined duration to form the CD-MOF-1 solution.

Embodiment 3. The method of embodiment 1, further comprising:
placing the polypropylene fabric on a meniscus of the intermediate solution being incubated;
adding methanol on top of the polypropylene fabric to form the MOF-coated fabric.

Embodiment 4. The method of embodiment 2, further comprising submerging the polypropylene fabric in the generated aqueous reaction solution during the incubation to form the MOF-coated fabric.

Embodiment 5. The method of embodiment 1, wherein loading the BAC-based surfactant on the MOF-coated fabric comprises:
dissolving 40 mg of BAC in 1 mL of EtOH to form a suspension;
adding the MOF-coated fabric to the suspension;
heating the suspension under stirring at 50° C. for a predetermined duration;
removing the MOF-coated fabric from the heated suspension;
sequentially dipping the MOF-coated fabric in 3 EtOH baths and 1 DCM bath; and
drying the dipped MOF-coated fabric in a vacuum oven at 50° C. for a predetermined duration.

Embodiment 6. The method of embodiment 1, further comprising performing a Brunauer-Emmett-Teller (BET) surface area analysis on one or more samples of the CD-MOF-1 solution by:
outgassing a 100 mg of the CD-MOF-1 solution for a duration of 15 minutes at 40° C.;
cooling the sample to a temperature of −196° C.; and
measuring Nitrogen adsorption from a partial pressure range of 0 to 0.2 bars.

Embodiment 7. The method of embodiment 1, wherein the one or more samples comprise one or more of a first sample that comprises CD-MOF-1 loaded with the BAC-based surfactant and a second sample that comprises an unloaded CD-MOF-1 solution.

Embodiment 8. The method of claim 1, further comprising performing a Powder X-Ray Diffraction (XRD) on at least one sample of the CD-MOF-1 solution over a predetermined duration to obtain at least one XRD pattern.

Embodiment 9. The method of embodiment 8, further comprising transferring the at least one sample to an Agate mortar to grind the at least one sample for a duration ranging between 10 to 15 minutes.

Embodiment 10. The method of embodiment 9, further comprising acquiring at least one diffraction pattern from the at least one sample, in a range of 3° to 45° with a step increase of 0.02° and a dwell time of 1 second using a Rigaku MiniFlex equipped with a Cu αK radiation source.

Embodiment 11. The method of embodiment 10, wherein the at least one sample comprises at least a first sample that comprises CD-MOF-1 loaded with the BAC-based surfactant and further wherein, a stability of the first sample is assessable based on a crystallinity indicated by the one or more XRD patterns.

Embodiment 12. The method of embodiment 11, wherein the at least one sample comprises at least a second sample that comprises an unloaded CD-MOF-1 solution.

Embodiment 13. The method of embodiment 11, further comprising subjecting the first sample to a varied humidity ranging between 27-44% RH and a temperature ranging between 22.5° C.-23.9° C., over a predetermined duration.

Embodiment 14. The method of embodiment 1, further comprising performing Raman spectroscopy on one or more samples of the CD-MOF-1 solution to acquire one or more accumulations, each at an exposure time of 10 seconds.

Embodiment 15. The method of embodiment 14, wherein the Raman spectroscopy is performed with a 633 nm beam source.

Embodiment 16. The method of embodiment 1, further comprising performing a Nuclear Magnetic Resonance (NMR) analysis on the antimicrobial fabric to obtain a percentage of BAC loading in the antimicrobial fabric.

Embodiment 17. The method of embodiment 1, further comprising performing an Ultraviolet-visible spectroscopy (UV/Vis) to determine a percentage of BAC loading in the antimicrobial fabric.

Embodiment 18. The method of embodiment 1, further comprising measuring a zone of bacterial inhibition for bacterial species comprising Pseudomonas aeruginosa (PA01), Staphylococcus aureus (ATCC 25923), and Escherichia coli (C Strain 27).

Embodiment 19. A method for synthesizing a cyclodextrin-based metal organic framework (CD-MOF-1) solution, the method comprising:
dissolving 326 mg of γ-CD in a 10 mL solution of distilled water including 112 mg of KOH in a reaction flask to generate an aqueous reaction solution;
sonicating the aqueous reaction solution for a duration ranging between 5 to 10 minutes;
filtering the aqueous reaction solution through a 0.2 μm polyvinylidene filter paper via a syringe into a ˜20 mL test tube to form a filtered solution;
adding 1 mL EtOH to the filtered solution in the test tube as an emulsifier;
placing the test tube in a glass bottle having 10 mL MeOH;
storing the glass bottle in a 50° C. oven for a duration of 12 hours;
removing the filtered solution from the glass bottle;
adding 1 mL MeOH to the removed solution to form an intermediate solution;
incubating the intermediate solution for a duration of 2 hours at room temperature;
collecting a solid precipitate from the intermediate solution through a 0.2 μm polyvinylidene filter paper;
washing the solid precipitate with EtOH and DCM; and
placing the washed solid precipitate in a 50° C. vacuum oven for a predetermined duration to form the CD-MOF-1 solution.

Embodiment 20. The method of embodiment 18, wherein the aqueous reaction solution comprises an 8:1 molar ratio of KOH:γ-CD.

The terms “comprising,” “including,” and “having,” as used in the claim and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures, and techniques other than those specifically described herein can be applied to the practice of the invention as broadly disclosed herein without resort to undue experimentation. All art-known functional equivalents of methods, devices, device elements, materials, procedures, and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the networks, devices, and/or modules described herein contain optional features that can be individually or together applied to any other embodiment shown or contemplated here to be mixed and matched with the features of such networks, devices, and/or modules.

While the invention has been described with respect to a limited number of embodiments, those skilled in the art, having benefit of this disclosure, will appreciate that other embodiments can be devised which do not depart from the scope of the invention as disclosed herein.

We claim:

1. A method for developing an antimicrobial fabric, the method comprising:
coating a cyclodextrin-based metal organic framework (CD-MOF-1) solution on a polypropylene fabric;
forming an MOF-coated fabric based on the CD-MOF-1 coating; and
loading a benzalkonium chloride (BAC)-based surfactant on the MOF-coated fabric to develop the antimicrobial fabric.

2. The method of claim 1, wherein the CD-MOF-1 solution is developed by:
dissolving 326 mg of γ-CD in a 10 mL solution of distilled water including 112 mg of KOH in a reaction flask to generate an aqueous reaction solution comprising an 8:1 molar ratio of KOH:γ-CD;
sonicating the aqueous reaction solution for a duration ranging between 5 to 10 minutes;
filtering the aqueous reaction solution through a 0.2 μm polyvinylidene filter paper via a syringe into a 20 mL test tube to form a filtered solution;
adding 1 mL EtOH to the filtered solution in the test tube as an emulsifier;
placing the test tube in a glass bottle having 10 mL MeOH;
storing the glass bottle in a 50° C. oven for a duration of 12 hours;
removing the filtered solution from the glass bottle;
adding 1mL MeOH to the removed solution to form an intermediate solution;
incubating the intermediate solution for a duration of 2 hours at room temperature;
collecting a solid precipitate from the intermediate solution through a 0.2 μm polyvinylidene filter paper;
washing the solid precipitate with EtOH and DCM; and
placing the washed solid precipitate in a 50° C. vacuum oven for a predetermined duration to form the CD-MOF-1 solution.

3. The method of claim 1, further comprising:
placing the polypropylene fabric on a meniscus of the intermediate solution being incubated;
adding methanol on top of the polypropylene fabric to form the MOF-coated fabric.

4. The method of claim 2, further comprising submerging the polypropylene fabric in the generated aqueous reaction solution during the incubation to form the MOF-coated fabric.

5. The method of claim 1, wherein loading the BAC-based surfactant on the MOF-coated fabric comprises:
dissolving 40 mg of BAC in 1 mL of EtOH to form a suspension;
adding the MOF-coated fabric to the suspension;
heating the suspension under stirring at 50° C. for a predetermined duration;
removing the MOF-coated fabric from the heated suspension;
sequentially dipping the MOF-coated fabric in 3 EtOH baths and 1 DCM bath; and
drying the dipped MOF-coated fabric in a vacuum oven at 50° C. for a predetermined duration.

6. The method of claim 1, further comprising performing a Brunauer-Emmett-Teller (BET) surface area analysis on one or more samples of the CD-MOF-1 solution by:
outgassing a 100 mg of the CD-MOF-1 solution for a duration of 15 minutes at 40° C.;
cooling the sample to a temperature of −196° C.; and
measuring Nitrogen adsorption from a partial pressure range of 0 to 0.2 bars.

7. The method of claim 1, wherein the one or more samples comprise one or more of a first sample that comprises CD-MOF-1 loaded with the BAC-based surfactant and a second sample that comprises an unloaded CD-MOF-1 solution.

8. The method of claim 1, further comprising performing a Powder X-Ray Diffraction (XRD) on at least one sample of the CD-MOF-1 solution over a predetermined duration to obtain at least one XRD pattern.

9. The method of claim 8, further comprising transferring the at least one sample to an Agate mortar to grind the at least one sample for a duration ranging between 10 to 15 minutes.

10. The method of claim 9, further comprising acquiring at least one diffraction pattern from the at least one sample, in a range of 3° to 45° with a step increase of 0.02° and a dwell time of 1 second using a Rigaku MiniFlex equipped with a Cu αK radiation source.

11. The method of claim 10, wherein the at least one sample comprises at least a first sample that comprises CD-MOF-1 loaded with the BAC-based surfactant and further wherein, a stability of the first sample is assessable based on a crystallinity indicated by the one or more XRD patterns.

12. The method of claim 11, wherein the at least one sample comprises at least a second sample that comprises an unloaded CD-MOF-1 solution.

13. The method of claim 11, further comprising subjecting the first sample to a varied humidity ranging between 27-44% RH and a temperature ranging between 22.5° C.-23.9° C., over a predetermined duration.

14. The method of claim 1, further comprising performing Raman spectroscopy on one or more samples of the CD-MOF-1 solution to acquire one or more accumulations, each at an exposure time of 10 seconds.

15. The method of claim 14, wherein the Raman spectroscopy is performed with a 633 nm beam source.
